(19) United States
(12) Patent Application Publication
(10) Pub. No.: US 2025/0192931 A1
(43) Pub. Date: Jun. 12, 2025

(54) CONCEPTS FOR TRANSMITTING DATA TO ONE OR MORE USERS

(71) Applicant: Fraunhofer-Gesellschaft zur Foerderung der angewandten Forschung e.V., Munich (DE)

(72) Inventors: Thomas FEHRENBACH, Berlin (DE); Baris GOEKTEPE, Berlin (DE); Cornelius HELLGE, Berlin (DE); Johannes DOMMEL, Berlin (DE); Lars THIELE, Berlin (DE)

(21) Appl. No.: 18/926,823

(22) Filed: Oct. 25, 2024

Related U.S. Application Data
(63) Continuation of application No. 17/965,607, filed on Oct. 13, 2022, now Pat. No. 12,143,321.
Application No. 17/965,607 is a continuation of application No. 16/787,795, filed on Feb. 11, 2020, now Pat. No. 11,489,639.
Application No. 16/787,795 is a continuation of application No. PCT/EP2018/071806, filed on Aug. 10, 2018.

(30) Foreign Application Priority Data
Aug. 11, 2017 (EP) 17185935.8

(51) Int. Cl. H04L 5/00; H04B 7/024; H04W 72/044; H04W 92/20

(52) U.S. Cl. CPC H04L 5/0026; H04B 7/024; H04L 5/0035; H04L 5/0044; H04W 72/044; H04W 92/20

(57) ABSTRACT

A base station for a wireless communication network includes a plurality of base stations, each base station to serve one or more users. One or more users are served by a plurality of base stations to receive a first data signal from the base station and a second data signal from at least one further base station using multi-user superposition transmission, MUST. The base station includes a backhaul interface for a communication with one or more of the plurality of base stations of the wireless communication network. For transmitting the first data signal to one or more users served by the base station and by the further base station, the base station is configured to negotiate a MUST setting with the further base station via the backhaul interface, and map data of the first data signal using a first transmit constellation set according to the negotiated MUST setting.

### CROSS-REFERENCE TO RELATED APPLICATIONS

This application is a continuation of copending U.S. patent application Ser. No. 17/965,607, filed Oct. 13, 2022, which in turn is a continuation of U.S. patent application Ser. No. 16/787,795 filed Feb. 11, 2020 (U.S. Pat. No. 11,489,639 issued Nov. 1, 2022), which is a continuation of International Application No. PCT/EP2018/071806, filed Aug. 10, 2018, which is incorporated herein by reference in its entirety, and additionally claims priority from European Application No. 17185935.8, filed Aug. 11, 2017, which is also incorporated herein by reference in its entirety.

### BACKGROUND OF THE INVENTION

The present invention relates to the field of wireless or wired communication networks or systems, more specifically to the concepts for transmitting data to one or more users. Embodiments of the present invention concern the Multi User Superposition Transmission, MUST, of data to one or more users by a plurality of transmitters, like base stations. Other embodiments of the present invention concern the transmission of data to a plurality of users by a transmitter, like a base station, employing Multiple Input Multiple Output, MIMO, techniques.

FIG. 1 is a schematic representation of an example of a wireless network 100 including a core network 102 and a radio access network 104. The radio access network 104 may include a plurality of base stations eNB₁ to eNB₅, each serving a specific area surrounding the base station schematically represented by respective cells 106₁ to 106₅. The base stations are provided to serve users within a cell. A user may be a stationary device or a mobile device. Further, the wireless communication system may be accessed by mobile or stationary IoT devices which connect to a base station or to a user. The mobile devices or the IoT devices may include physical devices, ground based vehicles, such as robots or cars, aerial vehicles, such as manned or unmanned aerial vehicles (UAVs), the latter also referred to as drones, buildings and other items having embedded therein electronics, software, sensors, actuators, or the like as well as network connectivity that enable these devices to collect and exchange data across an existing network infrastructure. FIG. 1 shows an exemplary view of only five cells, however, the wireless communication system may include more such cells. FIG. 1 shows two users UE₁ and UE₂, also referred to as user equipment (UE), that are in cell 106₂ and that are served by base station eNB₂. Another user UE₃ is shown in cell 106₄ which is served by base station eNB₄. The arrows 108₁, 108₂ and 108₃ schematically represent uplink/downlink connections for transmitting data from a user UE₁, UE₂ and UE₃ to the base stations eNB₂, eNB₄ or for transmitting data from the base stations eNB₂, eNB₄ to the users UE₁, UE₂, UE₃. Further, FIG. 1 shows two IoT devices 110₁ and 110₂ in cell 106₄, which may be stationary or mobile devices. The IoT device 110₁ accesses the wireless communication system via the base station eNB₄ to receive and transmit data as schematically represented by arrow 112₁. The IoT device 110₂ accesses the wireless communication system via the user UE₃ as is schematically represented by arrow 112₂. The respective base station eNB₁ to eNB₅ may be connected to the core network 102, e.g. via the S1 interface, via respective backhaul links 114₁ to 114₅, which are schematically represented in FIG. 1 by the arrows pointing to “core”. The core network 102 may be connected to one or more external networks. Further, some or all of the respective base station eNB₁ to eNB₅ may connected, e.g. via the X1 or X2 interface, with each other via respective backhaul links 116₁ to 116₅, which are schematically represented in FIG. 1 by the arrows pointing to “enBs”

The wireless network or communication system depicted in FIG. 1 may by an heterogeneous network having two distinct overlaid networks, a network of macro cells with each macro cell including a macro base station, like base station eNB₁ to eNB₅, and a network of small cell base stations (not shown in FIG. 1), like femto or pico base stations.

For data transmission a physical resource grid may be used. The physical resource grid may comprise a set of resource elements to which various physical channels and physical signals are mapped. For example, the physical channels may include the physical downlink and uplink shared channels (PDSCH, PUSCH) carrying user specific data, also referred to as downlink and uplink payload data, the physical broadcast channel (PBCH) carrying for example a master information block (MIB) and a system information block (SIB), the physical downlink and uplink control channels (PDCCH, PUCCH) carrying for example the downlink control information (DCI), etc. For the uplink, the physical channels may further include the physical random access channel (PRACH or RACH) used by UEs for accessing the network once a UE synchronized and obtained the MIB and SIB. The physical signals may comprise reference signals (RS), synchronization signals and the like. The resource grid may comprise a frame having a certain duration, like 10 milliseconds, in the time domain and having a given bandwidth in the frequency domain. The frame may have a certain number of subframes of a predefined length, e.g., 2 subframes with a length of 1 millisecond. Each subframe may include two slots of 6 or 7 OFDM symbols depending on the cyclic prefix (CP) length.

The wireless communication system may be any single-tone or multicarrier system using frequency-division multiplexing, like the orthogonal frequency-division multiplexing (OFDM) system, the orthogonal frequency-division multiple access (OFDMA) system, or any other IFFT-based signal with or without CP, e.g. DFT-s-OFDM. Other waveforms, like non-orthogonal waveforms for multiple access, e.g. filter-bank multicarrier (FBMC), generalized frequency division multiplexing (GFDM) or universal filtered multi carrier (UFMC), may be used. The wireless communication system may operate, e.g., in accordance with the LTE-Advanced pro standard or the 5G or NR (New Radio) standard.

In the wireless communication network as shown in FIG. 1 the radio access network 104 may be a heterogeneous network including a network of primary cells, each including a primary base station, also referred to as a macro base station. Further, a plurality of secondary base stations, also referred to as small cell base stations, may be provided for each of the macro cells. FIG. 2 is a schematic representation of a cell, like cell 106₁ in FIG. 1, having two distinct overlaid networks, the networks comprising a macro cell network including the macro cell 106₁, and a small cell network. Although FIG. 2 represents only a single macro cell, it is noted that one or more of the other cells in FIG. 1 may also use the overlaid networks. The small cell network comprises a plurality of small cell base stations SeNB₁ to SeNB₅ each operating within a respective area 120₁ to 120₅, also referring as the coverage area of the small cell. The small cell base stations SeNB₁ to SeNB₅ may be controlled by the macro cell base station MeNB₁ to which the respective small cell base stations SeNB₁ to SeNB₅ are connected via respective backhaul links 122₁ to 122₅. Rather than connecting the small cell base stations via the backhaul links to the macro cell base station, one or more of the small cell base stations may be coupled to the core network via respective backhaul links. FIG. 2 further shows a user equipment UE being served by the macro cell base station MeNB₁ as indicated by arrow 124₁ and by the small cell base station SeNB₁, as indicated schematically by the arrow 124₂.

FIG. 3 is a further schematic representation of a plurality of small cells 120₁ to 120₃ of a macro cell (not shown). The macro cell may be similar to that in FIG. 2. Each small cell may serve one or more UEs. The respective small cell base stations SeNB₁, SeNB₂, SeNB₃, . . . , other than in FIG. 2, are connected via the backhaul links or connections 102₁ to 102₃ to the core network 102. The respective small cells 102₁ to 102₃ may be directly connected with each other via the X2 interface, as schematically indicated in FIG. 3. The transport network connecting the respective small cells to the core network 102 may be an optical fiber network including one or more points of presence (PoP) at which a plurality of small cells are connected to the transport network. Further details about a backhaul architecture as shown in FIG. 3 is described in reference [1].

The small cells, also referred to as secondary mobile communication cells, SCs, form an overlay network to the network of macro cells, also referred to as primary mobile communication cells, PC. The small cells may be connected via backhaul links (BL) to the macro cell (FIG. 2) and/or to the core network (FIG. 3). The backhaul links may be wired or wireless links, and in case of connecting the small cells via the backhaul links to the core network, the point of presence (PoP) of the transport network (FIG. 3) may serve as an interface to the core network. Each small cell may serve a number of mobile users UE within its coverage area by means of a wireless access link (AL) 124₂. Further, the UEs may be connected to the primary cell, for example to receive control signals, and the connection may be referred to as a control link (CL).

In wireless communication networks as described above with reference to FIG. 1 to FIG. 3, a Multi User Superposition Transmission, MUST, of data may be used. For example, in accordance with LTE, MUST for the downlink (DL) is described in reference [2]. MUST is used as a downlink scheme, namely a multiple access scheme were multiple users are co-scheduled on the same physical resource elements without spatial separation. Such a non-orthogonal transmission allows to improve the multi user (MU) system capacity and/or number of connected devices in the network. The base station (BS) on the transmit side creates composite transmit (TX) constellations for independent data streams. At the receiver side, the data streams may be separated, e.g., by receiver structures using successive interference cancellation. For the downlink (DL) direction the three MUST categories indicated in table 1 below are specified in reference [2]

TABLE 1
Classification of MUST schemes and their key characteristics

| | | Gray | Label-bit |
|---|---|---|---|
| Category | Power Ratio | Mapping | assignment |
| MUST | Adaptive, on | N | On component |
| Category 1 | component | | constellation |
| | constellations | | |
| MUST | Adaptive, on | Y | On the composite |
| Category 2 | component | | constellation |
| | constellations | | |
| MUST | N/A | Y | On the composite |
| Category 3 | | | constellation |

An example for the transmitter side processing for category 1 is shown in FIG. 4. Data to be transmitted using MUST is provided in a first transport block TB₁ and in a second transport block TB₂. After independent channel coding, rate matching (RM) and scrambling at 202₁, 202₂ as well as independent mapping to the modulation symbols at 204₁, 204₂, the signals carrying the data for a first UE close or near to the transmitter, also referred to as a MUST-near UE, and the data for a second UE far from the transmitter, also referred to as a MUST-far UE (the first UE is closer to the transmitter than the second UE), are weighted at 206 with the amplitude weights \sqrt{α} and \sqrt{1−α}, respectively, where α is the transmission power ratio for the MUST-near user, and combined at 208. FIG. 5 shows an example composite constellation of MUST Category 1. The above described DL-MUST is designed for point-to-multipoint transmission, however, it does not support multipoint transmission so that, e.g., there is no possibility to implement a coordinated multi-point transmission of data using MUST.

Further, the above described DL-MUST is implemented to transmit data to MUST-near and MUST-far UEs, also referred to as near and far UEs, i.e., only UEs having a significant SNR-gap or a large SNR difference are selected for the MUST and scheduled jointly on the same resource element(s). Assuming a high SNR near UE (with channel gain |h₁|²) and a low SNR far UE (with channel gain |h₂|²), with |h₁|>|h₂|. Thus, with a specific decoding order, the individual rates assuming a SIC receiver may be calculated as:

$${r}_{2} = B \cdot log ( 1 + \frac{{P}_{2} {\vert {h}_{2} \vert}^{2}}{{P}_{1} {\vert {h}_{2} \vert}^{2} + N} ) \qquad ( 1 )$$

$${r}_{1} = B \cdot log ( 1 + \frac{{{P}_{1} \vert {h}_{1} \vert}^{2}}{N} ) \qquad ( 2 )$$

The individual rates may be achieved by using a proper channel coding per Non-Orthogonal Multiple Access, NOMA, layer. However, in case the users have similar SNR, i.e., when |h₁|²≅|h₂|² it follows from (1) and (2) that for a fair power allocation P₁≅P₂ the individual rates are different, i.e. r₂<r₁ due to the SIC receiver which uses one stream to be decoded first and subtracted from the other. This leads to different SUM rates (=unfair) over time and no gain compared to orthogonal transmission (i.e. OFDMA). Thus, no MUST is applied for users with equal or substantially equal SNRs.

In a wireless communication system like the one depicted schematically in FIG. 1 to FIG. 3, multi-antenna techniques may be used, e.g., in accordance with LTE, to improve user data rates, link reliability, cell coverage and network capacity. To support multi-stream or multi-layer transmissions, linear precoding is used in the physical layer of the communication system. Linear precoding is performed by a precoder matrix which maps layers of data to antenna ports. The precoding may be seen as a generalization of beamforming, which is a technique to spatially direct/focus data transmission towards an intended receiver. Multiple users may be served by a single base station using MIMO techniques, which allow for a spatial precoding so as to serve each user by one dedicated beam. So far it has been assumed that the spatial precoding allows for an “orthogonal” transmission, i.e., interference free transmission, between layers. However, in reality, e.g., due to the limited feedback, the quantized beamformer, etc., there is a cross-layer interference, also referred to as cross-talk, leading to performance degradation. The effect of cross-layer interference mentioned above is now explained in more detail with reference to FIG. 6.

FIG. 6(a) shows a base station BS or gNB, which may also be a small cell base station, using beamforming techniques for providing data to a plurality of users UE₁, UE₂ using respective transmit beams B₁, and B₂ which are formed by linear precoding to be directed towards the respective users UE₁ and UE₂. The respective data or data streams D₁, D₂ for the users UE₁ and UE₂ are transmitted on the beams B₁, B₂. Further, FIG. 6(a) schematically represents the interference due to cross-talk between the respective beams B₁ and B₂. The interference at the first user UE₁ due to the second beam B₂ is schematically represented by the dashed line I₂₁. Likewise, the interference experienced by UE₂ due to beam B₁ is represented by the dashed line I₁₂. FIG. 6(a) also shows the respective receive constellations at the users UE₁ and UE₂ indicating how signal carrying only the data D₁, D₂ and signals only due to the interference I₁₂, I₂₁ would be received at the respective users UE₁, UE₂.

FIG. 6(b) represents the effects of the cross-talk interference at the respective users when the base station gNB sends out the data signals using the beams B₁, B₂ simultaneously. FIG. 6(b) illustrates the transmit constellation at the base station showing that the data D₁ for the first user UE₁ is represented by a constellation point in the upper left quadrant of the constellation diagram, whereas the data D₂ for the second user UE₂ is represented by a constellation point in the upper right quadrant of the constellation diagram. What is actually received at the users UE₁, UE₂ is represented by the receive constellations indicated for the respective users in FIG. 6(b), and depends on interferences I₂₁, I₁₂ experienced by the respective users UE₁, UE₂. As can be seen, for the first user UE₁, the interference I₂₁ from the second beam B₂ moves the received signal R₁ onto the y-axis of the constellation diagram so that the received signal R₁ cannot be decoded at the UE₁ correctly, as the UE₁ cannot judge whether the received signal R₁ should belong to the upper left quadrant or the upper right quadrant of the receive diagram. For UE₂, the interference I₁₂ from the first beam also causes a shift with regard to the constellation point, however, it is still within the upper right quadrant of the receive constellation which allows the user UE₂ to correctly decode in a signal D₂. Thus, in a scenario as depicted with reference to FIG. 6 a simultaneous transmission of data by respective beams to a plurality of users from a single base station at the same time may not be possible due to the interference among the respective beams causing at one or more of the users a situation in which the data originally sent cannot be correctly decoded.

### SUMMARY

An embodiment may have a base station for a wireless communication network, the wireless communication network including a plurality of base stations, each base station to serve one or more users, wherein one or more users are served by a plurality of base stations to receive a first data signal from the base station and a second data signal from at least one further base station using multi-user superposition transmission, MUST, the base station having: a backhaul interface for a communication with one or more of the plurality of base stations of the wireless communication network, wherein, for transmitting the first data signal to one or more users served by the base station and by the further base station, the base station is configured to negotiate a MUST setting with the further base station via the backhaul interface, and map data of the first data signal using a first transmit constellation set according to the negotiated MUST setting.

Another embodiment may have a user equipment for a wireless communication network, the wireless communication network including a plurality of base stations, each base station to serve one or more user equipments, wherein the user equipment is served by a plurality of base stations to receive a first data signal from a first base station and a second data signal from a second base station using multi-user superposition transmission, MUST, and wherein the user equipment is configured to receive and apply MUST settings for performing demapping on a superposition of the first and second data signals to obtain information data per data signal.

Another embodiment may have a base station for a wireless communication network, the base station to serve two or more users, wherein, a first user is served by the base station to receive a first data signal from the base station and a second user is served by the base station to receive a second data signal from the base station, the base station having: an antenna array for a wireless communication with the two or more users served by the base station, a precoder connected to the antenna array, the precoder causing the antenna array to form a first transmit beam to transmit the first data signal to the first user, and to form a second transmit beam to transmit the second data signal to the second user, wherein, for transmitting the first data signal to the first user, the base station is configured to map data of the first data signal using a first transmit constellation, and for transmitting the second data signal to the second user, the base station is configured to map data of the second data signal using a second transmit constellation, and wherein the precoder is configured to apply a predistortion responsive to an estimated cross-talk between the first and second transmit beams.

Another embodiment may have a user equipment for a wireless communication network, the wireless communication network including one or more base stations, one base station serving two or more user equipments using respective transmit beams, wherein the user equipment receives a first transmit beam and a second transmit beam from the base station and is configured to measure and signal to the base station one or more of a phase offset between the first and second transmit beams, an attenuation on the first and second transmit beams, an interference on the first and second transmit beams, and vectoring parameters for the first and second transmit beams.

According to another embodiment, a wireless communication network may have: a plurality of any one of the above inventive base stations, and a plurality of users and/or a plurality of any one of the above inventive user equipments.

According to another embodiment, a method for transmitting data to one or more users of a wireless communication network, the wireless communication network including a plurality of base stations, each base station to serve one or more users, wherein one or more users are served by a plurality of base stations to receive a first data signal from a first base station and a second data signal from at least a second base station using multi-user superposition transmission, MUST, may have the steps of: negotiating a MUST setting between the first and second base stations via a backhaul interface connecting a plurality of the base stations of the wireless communication network, mapping, according to the negotiated MUST setting, data of the first data signal using a first transmit constellation set by the first base station, and data of the second data signal using a second transmit constellation set, by the second base station, and transmitting the first and second data signals by the first and second base station.

According to still another embodiment, a method for transmitting data to a plurality of users of a wireless communication network, the wireless communication network including a base station serving the plurality of users, wherein a first user is served by the base station to receive a first data signal from the base station and a second user is served by the base station to receive a second data signal from the base station, may have the steps of: controlling an antenna array to form a first transmit beam to transmit the first data signal to the first user, and to form a second transmit beam to transmit the second data signal to the second user, mapping data of the first data signal using a first transmit constellation, and transmitting the first data signal to the first user, and mapping data of the second data signal using a second transmit constellation, and transmitting the second data signal to the second user, wherein, responsive to an estimated cross-talk between the first and second transmit beams, a predistortion is applied upon forming the first and second transmit beams.

Another embodiment may have a non-transitory digital storage medium having stored thereon a computer program for performing a method for transmitting data to one or more users of a wireless communication network, the wireless communication network including a plurality of base stations, each base station to serve one or more users, wherein one or more users are served by a plurality of base stations to receive a first data signal from a first base station and a second data signal from at least a second base station using multi-user superposition transmission, MUST, the method having the steps of: negotiating a MUST setting between the first and second base stations via a backhaul interface connecting a plurality of the base stations of the wireless communication network, mapping, according to the negotiated MUST setting, data of the first data signal using a first transmit constellation set by the first base station, and data of the second data signal using a second transmit constellation set, by the second base station, and transmitting the first and second data signals by the first and second base station, when said computer program is run by a computer.

Still another embodiment may have a non-transitory digital storage medium having stored thereon a computer program for performing a method for transmitting data to a plurality of users of a wireless communication network, the wireless communication network including a base station serving the plurality of users, wherein a first user is served by the base station to receive a first data signal from the base station and a second user is served by the base station to receive a second data signal from the base station, the method having the steps of: controlling an antenna array to form a first transmit beam to transmit the first data signal to the first user, and to form a second transmit beam to transmit the second data signal to the second user, mapping data of the first data signal using a first transmit constellation, and transmitting the first data signal to the first user, and mapping data of the second data signal using a second transmit constellation, and transmitting the second data signal to the second user, wherein, responsive to an estimated cross-talk between the first and second transmit beams, a predistortion is applied upon forming the first and second transmit beams, when said computer program is run by a computer.

Embodiments of the present invention enable a CoMP (Coordinated Multi Point) transmission with a limited amount of feedback using MUST. Further embodiments of the present invention allow applying MUST for users with equal or substantially equal SNRs.

Yet further embodiments of the present invention address the cross-layer interference between MIMO-layers used for transmitting data to a plurality of users.

### BRIEF DESCRIPTION OF THE DRAWINGS

Embodiments of the present invention are now described in further detail with reference to the accompanying drawings, in which:

FIG. 1 shows a schematic representation of an example of a wireless communication system;

FIG. 2 shows a schematic representation of a cell, like a cell in FIG. 1, having two distinct overlaid networks, namely a macro cell network including a macro cell and a small cell network including small cell base stations connected via backhaul links to the macro cell base station;

FIG. 3 shows a further schematic representation of a plurality of small cells of a macro cell, similar to FIG. 2, wherein the small cell base stations are connected via backhaul links to each other and to the core network;

FIG. 4 shows a block diagram of a transmission path of a base station for downlink MUST;

FIG. 5 shows a schematic diagram of a composite constellation of MUST category 1;

FIGS. 6a-b illustrates the simultaneous transmission of data to a plurality of users using respective beams formed at a base station, wherein FIG. 6(a) represents data signals and interference signals produced by the transmission and received at the users, and wherein FIG. 6(b) shows the influence of the interference signals on the signals as received at the users;

FIG. 7 is a schematic representation of a wireless communication network operating in accordance with the principles described herein;

FIGS. 8a-b is a schematic representation illustrating constellations of superposition data signals, wherein FIG. 8(a) illustrates the constellation resulting from a power allocation at two base stations serving one or more users, and wherein FIG. 8(b) illustrates the constellations of the superposition data signals when, additionally due to the power allocation, also a phase offset compensation at at least one of the base stations is applied;

FIG. 9 is a block diagram of users and base stations in accordance with an embodiment of the present application for transmitting, in a superpositioned manner, a data signal to a user;

FIG. 10 illustrates an embodiment of the inventive approach in accordance with which one UE is served by two base stations BS₁, BS₂;

FIGS. 11a-b illustrates an embodiment in which two base stations serve different users, of which at least one user is operated in a MUST-UE COMP mode, wherein FIG. 11(a) illustrates the setup for serving a first user by a first base station and a second user by a second base station, and wherein FIG. 11(b) illustrates rotations of the constellations of data signals as received at a UE owing to a channel phase offset of the channels via which the data signals arrive at the UE;

FIG. 12 is a schematic block diagram of a user in accordance with embodiments of the present invention;

FIGS. 13a-b illustrates the data rates over time when applying MUST at users having equal or substantially equal SNR, wherein FIG. 13(a) shows the data rates achievable over time by known approaches, and wherein FIG. 13(b) shows the data rates achievable over time in accordance with embodiments of the present invention;

FIG. 14 illustrates the compensation of cross-talk in accordance with an embodiment of an inventive approach.;

FIG. 15 illustrates a block diagram of a network for implementing the approach described with reference to FIG. 14; and

FIG. 16 illustrates an example of a computer system on which units or modules as well as the steps of the methods described in accordance with the inventive approach may execute.

### DETAILED DESCRIPTION OF THE INVENTION

In accordance with the present invention an approach for a downlink communication using MUST to one or more users is provided. This allows for a more efficient use of the resources available for the communication between the base stations and the users and also for an improved data transmission.

The present invention provides a base station for a wireless communication network. The wireless communication network includes a plurality of base stations. Each base station serves one or more users, wherein one or more users are served by a plurality of base stations to receive a first data signal from the base station and a second data signal from at least one further base station using multi-user superposition transmission, MUST. The base station comprises a backhaul interface for a communication with one or more of the plurality of base stations of the wireless communication network, wherein, for transmitting the first data signal to one or more users served by the base station and by the further base station, the base station is configured to negotiate a MUST setting with the further base station via the backhaul interface, and to map data of the first data signal using a first transmit constellation set according to the negotiated MUST setting.

The present invention provides a user equipment for a wireless communication network. The wireless communication network includes a plurality of base stations, each base station to serve one or more user equipments. The user equipment is served by a plurality of base stations to receive a first data signal from a first base station and a second data signal from a second base station using multi-user superposition transmission, MUST. The user equipment is configured to receive and apply MUST settings for performing demapping on a superposition of the first and second data signals to obtain information data per data signal.

In accordance with embodiments, the above described MUST settings negotiated among the BSs may include or indicate the physical resources allocated to the one or more users for transmitting the first and second data signals, and a power allocation for the one or more users. In accordance with further embodiments, also information about the constellation maps used by the base stations may be indicated, the constellation map representing a complex representation of the binary data, e.g., the bit to QAM mapping. When indicating both the allocated power and the constellation map, this may be referred to as a MUST layer. The information about the constellation maps may include information about a phase offset between the constellation maps. For example, a constellation map may contain the power allocation, and the length of a complex vector in the constellation map may represent the power.

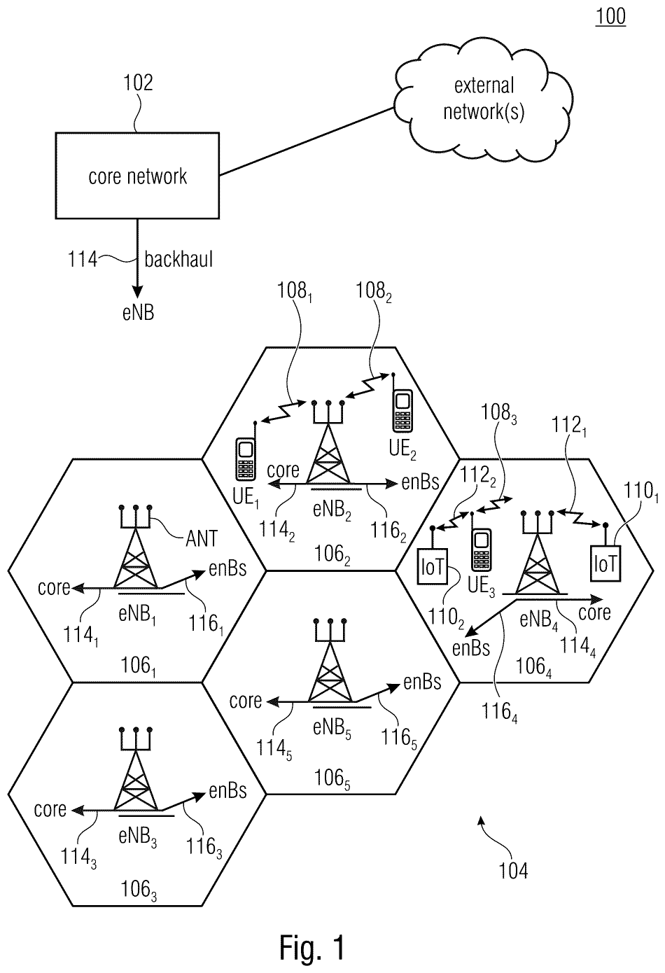

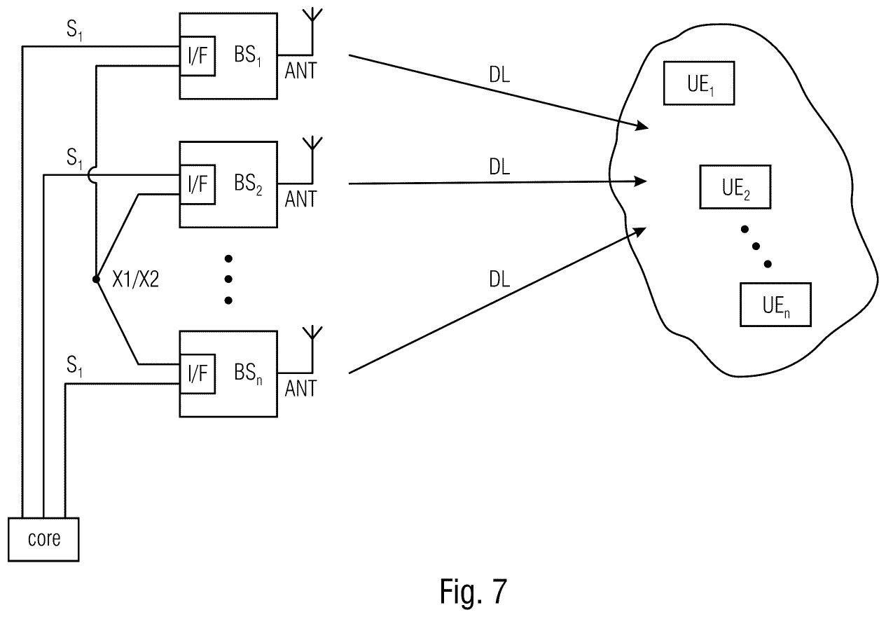

FIG. 7 is a schematic representation of a wireless communication network operating in accordance with the principles described herein. The wireless communication system may be a communication system as described with reference to one of FIG. 1 to FIG. 3, or it may include a combination of the above-described networks. FIG. 7 shows a plurality of base stations BS₁ to BSₙ each including an interface I/F for connection to a backhaul of the network, which may be a backhaul connection via the core of the network, for example via the S₁ interface, and/or a direct connection of the respective base stations, for example via the X₁/X₂ interface. Each of the base stations may comprise an antenna ANT for a wireless communication within the network and in accordance with the inventive approach, a downlink communication is provided to a plurality of users UE₁ to UEₙ. In accordance with the present invention, a transmission of data using MUST to one or more of the users UE₁ to UEₙ is provided using a plurality of coordinated base stations. For example, two or more of the base stations BS₁ to BSₙ may be used for a downlink communication to UE₁ or to a plurality of users selected from UE₁ to UEₙ for the downlink communication of data using MUST. For example, individual MUST layers, also referred to as near/far MUST layers may be transmitted by a coordinated set of base stations BS₁ to BSₙ to a coordinated set of users UE₁ to UEₙ which also includes the transmission of the data from a plurality of base stations to only one user. To allow for the serving of one or more users by at least two base stations using MUST, the inventive approach coordinates the involved base stations via the backhaul connections of the base stations. For example, when considering the transmission of individual MUST layers by base stations BS₁ and BS₂ to user UE₁ or to users UE₁ and UE₂, the base stations BS₁ and BS₂, via the backhaul interfaces I/F negotiate the MUST setting(s) among each other so that each of the base stations can map the respective data signals to be sent via the downlink towards the user(s) using a respective transmit constellation which is set according to the negotiated MUST setting.

The MUST setting, in accordance with embodiments, indicates for example the physical resources allocated to the one or more users, for example the resource blocks or resource elements where the UEs are scheduled. In accordance with further embodiments, information about the power allocation for the one or more users may be included in the MUST setting and/or information about the constellation maps to be used by the base stations. A constellation map represents a complex representation of the binary data, for example the bit-to QAM mapping together with the power allocation. One or more of the above parameters may be included in the MUST settings negotiated among the base station involved in the downlink MUST communication with the one or more users. In accordance with other embodiments, in addition, a phase offset between the respective constellation maps may be included in the MUST setting, for example in cases where the distances between the base stations and the users is different resulting in a substantial phase offset between the channels from the respective base stations to the respective users, or in scenarios, in which a phase offset may be caused by other means.

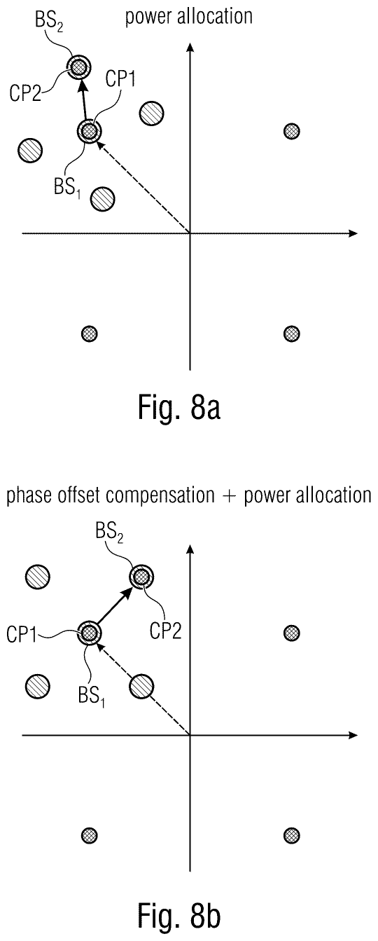

FIG. 8 is a schematic representation illustrating constellations of superposition data signals.

FIG. 8(a) illustrates the effect of a power allocation control at first and second base stations BS₁, BS₂ of which the second base station transmits its data using MUST. In the example depicted in FIG. 8(a) BS₁ mapped its data to be transmitted onto a constellation point CP₁ in the upper left quadrant as shown by the dotted line arrow, and BS₂ mapped its data to be transmitted onto a constellation point CP2 in the upper left hand quadrant as shown by the continuous line arrow. The user may demap the superposition of the received data signals, e.g., by subjecting the mapped superposition (to which the continuous line arrow points) to a successive interference cancellation process. FIG. 8(a) further illustrates a rotation of a QAM constellation points of the second base station BS₂ relative to the constellation points of a QAM constellation of the first base station BS₁ in the complex domain. The rotation may result from a phase offset between a first channel from the first base station BS₁ to a user and a second channel from the second base station BS₂ to a user, e.g., due to an arbitrary difference in the channels. Both base stations are power controlled so that the data signal from BS₂ arrives at the user with less power when compared to the data signal from BS₁ manifesting itself in the QAM constellation points of BS₂ being less spread, or demagnified, relative to the QAM constellation of BS₁.

In accordance with embodiments, also a phase offset compensation may be implemented, e.g., to compensate a rotation of QAM constellation points of the second base station BS₂ relative to the constellation points of a QAM constellation of the first base station BS₁ in the complex domain, e.g., due to an arbitrary difference in the channels. The phase offset compensation may include a signaling among the base stations involved in the MUST DL communication so that at least some of the base stations provide for pre-rotating its QAM constellation. In accordance with other embodiments, one base station may have a fixed phase for its constellation map, and the one or more other base stations may receive phase offset information for pre-rotating its QAM constellation relative to the fixed phase constellation of the one base station. For example, when a first base station has its phase fixed, a second base station may receive from a user served by the second base station a phase offset between the first base station and the second base station, and apply the received phase offset to its constellation map so that the second base station may pre-rotate its constellation relative to the fixed phase constellation of the first base station.

FIG. 8(b) shows the an example assuming a fixed phase constellation for BS₁ in which a phase offset (represented by the rotation in FIG. 8(a)) has been compensated. Both base stations BS₁ and BS₂ are power controlled as described above. The compensation may be performed by pre-rotating the BS₂ QAM constellation appropriately in order to compensate for, or reduce, a phase shift which the data signals from BS₁, BS₂ experience on their way to the user(s). As can be seen from FIG. 8(b), the constellation points of BS₂ are now registered to the axes of the complex domain just as the constellation points of the constellation of BS₁. In this example, in which both constellations of BS₁ and BS₂ are of the same type, namely QAM, the constellation points of BS₂ may be transformed onto the constellation points of BS₁ by a translatory shift and isotropic scaling in the complex domain exclusively, i.e. no rotation is necessary.

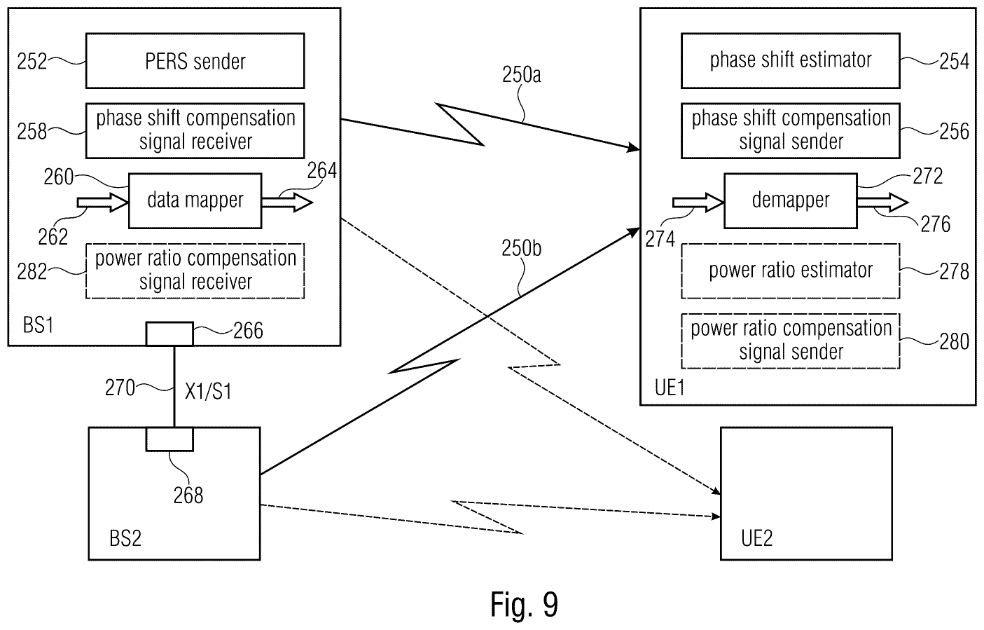

For compensating the phase shift, e.g., in a way as explained above, the phase offset needs to be determined. The phase shift, in accordance with embodiments, may be determined in a way as described in FIG. 9, which shows the users UE₁, UE₂ and the base stations BS₁, BS₂. For the subsequent discussion, it is assumed that both base station BS₁, BS₂ transmit data to the UE₁ using MUST, however, in accordance with other embodiments (as depicted by the dotted line arrows), first data may be transmitted from base station BS₁ to UE₁ and second data may be transmitted using MUST from base station BS₂ to UE₂. In the following, details of BS₁ are described, and, dependent on the circumstances, BS₂ may or may not have the same structure.

UE₁ receives data signals transmitted over radio channels 250a, 250b by BS₁ and BS₂ using multi-user superposition coding or MUST. BS₁ includes a phase shift estimation reference signal (PSERS) sender 252 configured to send a phase shift estimation reference signal to UE₁. The phase shift estimation reference signal enables UE to estimate a phase shift between the channels 250a, 250b. In a similar manner, BS₂ does the same, i.e. sends a PSERS via its connecting channel 250b to UE₁. UE₁ includes a phase shift estimator 254 for estimating a phase shift between the channels 250a, 250b. To this end, the phase shift estimator 254 may evaluate the phase shift estimation reference signals received from BS₁ and BS₂, respectively. UE includes a phase shift compensation signal sender 256 which receives from the phase shift estimator 254 the information about the phase shift between the channels 250a, 250b and sends a phase shift compensation signal to at least one of the base stations BS₁, BS₂. In FIG. 9 it is assumed that BS₁ receives the phase shift compensation signal sent by sender 256. To this end, BS₁ includes a phase shift compensation signal receiver 258. The phase shift compensation signal is selected such that the phase shift compensation signal leads to a reduction or compensation of any phase shift between the channels 250a, 250b. Such a phase shift may result from different distances of BS₁ and BS₂ from UE₁.

BS₁ includes a mapper 260 which maps data 262 to be transmitted using a certain constellation in a phase shift compensated manner according to the phase shift compensation signal, thereby obtaining the data signal 264 finally to be sent over channel 250a to UE₁ in a manner superimposed by a corresponding data signal sent from BS₂. For example, the data mapper 260 maps the data 262 to be transmitted onto a certain constellation selected, for instance, on the basis of certain channel conditions such as QPSK, QAM or the like. The data mapper 260 rotates its constellation to account for the phase shift between its channel 250a and the channel 250b of the multiple-user superposition partner BS₂. The obtained data signal 264 is then, for instance, used to form a certain OFDM subcarrier of an OFDM or SC-FDM or OFDMA or SC-FDMA signal finally sent out by BS₁ to UE₁ so that the mentioned subcarrier coincides with the subcarrier onto which a corresponding mapper of BS₂ maps its own data. BS₁ and BS₂ include respective backhaul interfaces 266, 268, like S1, X1 or X2 interfaces, for communicating with each other via a backhaul link 270, which may be a wired link, like an electrical or optical link, or a wireless link, like a microwave link. In the depicted embodiment, it is assumed that BS₁ and BS₂ negotiated the MUST settings to the extent that BS₁ and BS₂ are aware of the common resources, like RBs or REs, and the power allocated for the transmission of data from BS₁ to UE₁ and from BS₂ to UE₁. This may be negotiated by a signaling via the backhaul link 270. Also information about the phase offset may be signaled.

UE₁ includes a demapper 272 which receives the superpositioned data signal, i.e. the superposition of the data signal on the corresponding OFDM subcarrier, indicated at 274, which points to a certain point in the complex plane, and obtains, by performing the demapping, an information data for each data signal, i.e. data signal 276 sent from BS₁ and the corresponding data signal sent from BS₂. To this end, the demapper 272 may perform a successive interference cancellation (SIC) so that the demapper 272 obtains the information data for the “stronger” data signal first, i.e. the data signal from the “nearer” transmitter, and then derives the information data for the “farther” transmitter. The demapping may be a hard demapping with the information data being one or more bits, or may be a soft demapping with the information data being values between 0 and 1, both inclusively. The information data 276 thus obtained by the demapper 272 for BS₁ and BS₂, respectively, may then be subject to further processing such as channel decoding including, for instance, deinterleaving, forward error correction, descrambling, depuncturing or the like, performed separately for each base station BS₁ and BS₂, respectively. In such scenarios, BS₁, BS₂ may comprise a corresponding channel coder, interleaver, scrambler, and/or puncturer upstream the data mapper 260, and UE₁ may comprise upstream the demapper 272, a decomposer decomposing inbound OFDM, SC-FDM or OFDMA or SC-FDMA symbols into OFDM subcarriers, among which one carries the superpositioned data signal.

In accordance with embodiments, BS₂ may not take into account any phase shift compensation when mapping data for the transmission to UE₁, e.g., BS₂ may use a fixed phase for its constellation map. BS₂ may send the phase offset information received from UE₁ to BS₁ via the backhaul 270 for allowing BS₁ to pre-rotate its QAM constellation relative to the fixed phase constellation.

In accordance with further embodiments, BS₂ may not comprise a phase shift compensation signal receiver and/or may not take into account any phase shift compensation when mapping data for the transmission to UE₁. BS₂ may even be agnostic with respect to the fact that transmitter BS₁ transmits, in a piggyback manner, a further data signal which is then subject to multi-user superposition decoding at UE₁ in the manner described above.

In accordance with yet further embodiments of the present application UE₁ may optionally (as indicated by the dotted boxes) include a power ratio estimator 278 configured to estimate a power ratio between the plurality of base stations to obtain a power ratio information. A sender 280 sends a power ratio compensation signal depending on the power ratio information to at least one of BS₁ and BS₂, which may optionally include a power ratio compensation signal receiver 282. BS₁ may set a power at which the data signal 264 is transmitted depending on the power ratio compensation signal. In effect, the power set may affect the whole set of subcarriers which the subcarrier of data signal 264 is part of. That is, the whole OFDM/SC-FDM/OFDMA/SC-FDMA symbol carrying a plurality of OFDM subcarriers including the one onto which data mapper 260 has mapped the data 262, may be subjected to a power setting according to the power ratio compensation signal received. The power ratio compensation signal may be used for reducing a deviation of the power at which the data signals participating in the multi-user superposition coding superimpose each other at UE₁ so that the constellation points may be distributed in the complex domain most efficiently.

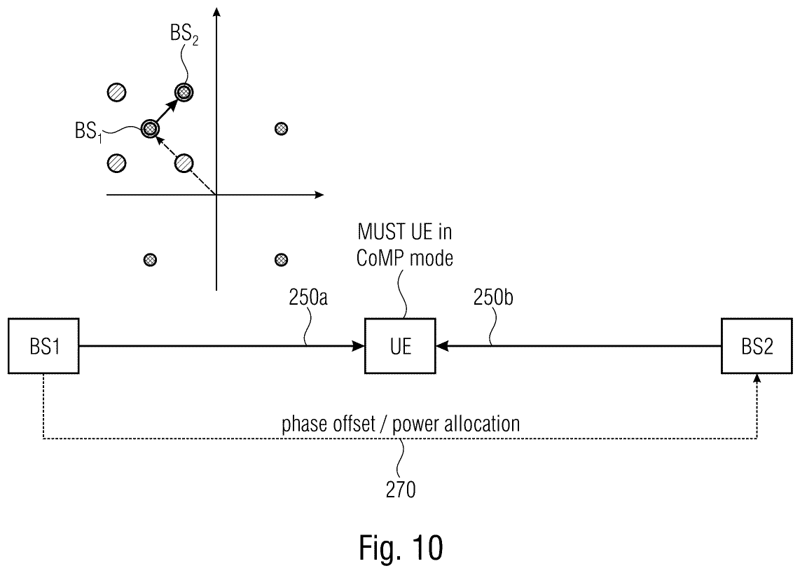

FIG. 10 illustrates an embodiment of the inventive approach in accordance with which one UE is served by two base stations BS₁, BS₂. The UE may be referred to as a MUST UE in COMP mode (coordinated multipoint mode). A multipoint-to-point-transmission is implemented in accordance with which the two base stations BS₁ and BS₂ transmit individual MUST layers via respective channels 250a and 250b to one user UE. To coordinate the operation of the base stations BS₁, BS₂, such that the two base stations transmit the data in a way as shown in the constellation diagram in FIG. 10, which corresponds to the one explained above with reference to FIG. 8(b), the base stations negotiate the MUST setting(s), for example the above mentioned resource elements to be used, the power location and/or the phase offset. In the scenario depicted in FIG. 10, the user UE and the base stations BS₁, BS₂ may be operated in a way as described in detail above with reference to FIG. 9.

The embodiments described above assumed that both base station BS₁, BS₂ transmit data to the UE₁ using MUST, however, in accordance with other embodiments, data may be transmitted from base station BS₁ to UE₁ and additional data may be transmitted using MUST from base station BS₂ to UE₂.

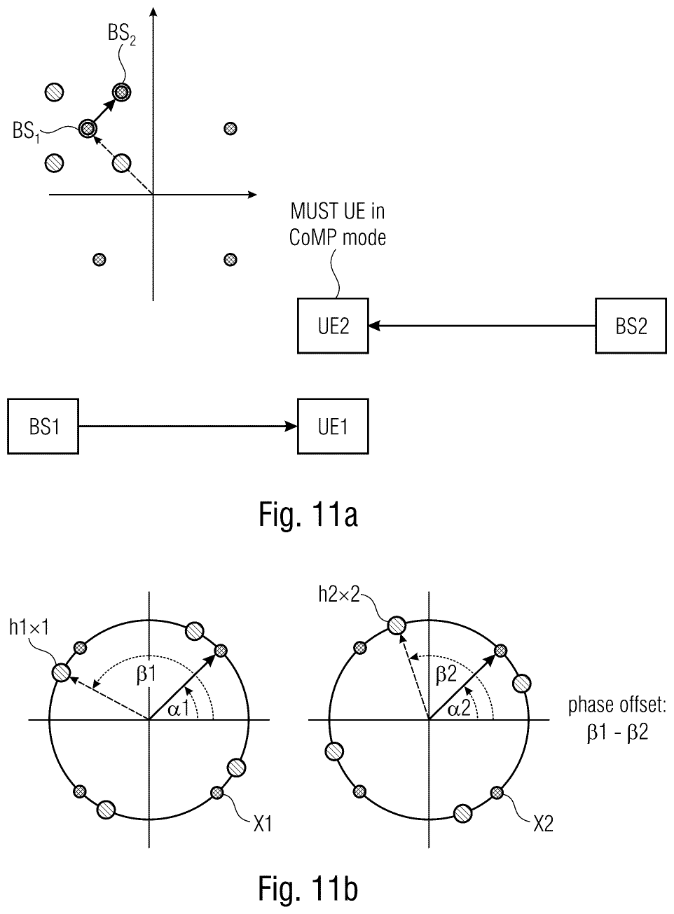

FIG. 11 illustrates such an embodiment, in accordance with which two base stations BS₁ and BS₂, serve respective users UE₁ and UE₂ of which user UE₂ is operated in the MUST-UE COMP mode mentioned above. FIG. 11(a) illustrates the setup for serving UE₁ by BS₁ and for serving UE₂ by BS₂. In addition, the constellation diagram, similar to the one of FIG. 8(a) is depicted illustrating that BS₁ maps its data onto a constellation point in the upper left quadrant as shown by the dotted line arrow, and that BS₂ maps its data to be transmitted onto a constellation point also in the upper left-hand quadrant as shown by the continuous line arrow. FIG. 11(b) illustrates rotations of the constellations of data signals as received at a UE or receiver owing to a channel phase offset of the channels via which the data signals arrive at the receiver while illustrating the resulting phase offset shift therebetween, i.e. illustrating the phase offset from BS₁ to BS₂ as seen at UE₂.

More specifically, FIG. 11(b) illustrates how the constellations of inbound component data signals at the UE₂ are affected by the channel phase. The data signal, the constellation of which is shown in the left-hand side of FIG. 11(b), arrives by an angle β1−α1 so that the QAM top right constellation point is at angle β1, whereas the second data signal's QAM constellation is tilted by angle β2−α2 so that the top right hand constellation QAM point occurs at β2, with the phase offset or phase shift relative between both data signals being β1−β2.

The embodiment described above with reference to FIG. 11 may be provided for allowing for an interference coordination when transmitting data from BS₁ to UE₁ and, using the same resources and the MUST approach for transmitting data from BS₂ to UE₂. In a similar way as described above with reference to FIG. 7 to FIG. 10, also in the embodiment of FIG. 11 the base stations BS₁ and BS₂ may be connected via a backhaul connection, like an X1, X2 or S1 interface, for a signaling to allow for interference coordination and management. In accordance with embodiments, resource and power allocations are exchanged, as described above, which allows the respective base stations to adjust their MCS level according to the interference from the MUST layer. For example, a base station may exchange with another base station information about the transmission power on the MUST resources to adjust the MCS level according to an interference from the MUST layer used by the other base station. In accordance with embodiments, the information about the transmission power on the MUST resources may include or contain resource and power allocations. The transmitted information may be an offset or interference estimate from the normal transmit power and not the actual power allocation. Additional signaling from the UEs may be needed, in accordance with yet further embodiments, to assist the network. For example, the received power levels (CSI) representing the attenuation of the paths from the respective UEs to the base stations may be provided to calculate the interference as seen by the UEs. In addition, in accordance with other embodiments the UE₂ may send phase offset information, for example information as explained above with FIG. 11(b) to adjust a phase difference between BS₁ and BS₂. This may be done using an absolute phase difference or iteratively by tracking and adjusting the phase of one base station. The signaling of the UE₂ may be via the UCI or RRC to its connected base station BS₂. In accordance with other embodiments, this information may be passed on to the base station BS₁ from the base station BS₂ via the backhaul link. Alternatively, the information may be provided directly from the UE₂ to the BS₁ via a radio link.

Thus, the embodiment of FIG. 11 may be implemented to improve an inter-cell DL interference situation in which UE₁ and UE₂ are positioned near to each other and UE₂ is in the MUST mode so as to receive a DL signal from BS₂ piggy packed onto the signal which UE₁ receives on the same physical resource from BS₁. UE₁ may even be agnostic with respect to this circumstance. Possibly, neither UE₁ nor UE₂ is in carrier aggregation mode. BS₂ may send out the PSERS by its sender 252 and operate as described with reference to FIG. 9 in detail for mapping the data to be send. In accordance with embodiments, BS₁ may merely send out a PSERS, but it may not implement the techniques described with reference to FIG. 9 in detail. UE₂ may have the special, above described demapping functionality, but is not interested in obtaining the information data for the data signals sent from BS₁, but merely uses MUST to separate the information data conveyed by data signals from BS₂ from those of BS₁. Otherwise, UE₂ may have the structure as described above in FIG. 9. UE₁ may or may not have the MUST demapping functionality. UE₂ receives two PSERS, one from BS₁ and another one from BS₂. As UE₂ is served by BS₂, it may signal the phase shift compensation signal to BS₂. BS₂ may forward to BS₁ the phase shift compensation signal it receives from UE₂ for controlling the phase shift compensation in data mapping and/or control phase shift compensation in data mapping itself. Similar issues may be performed with respect to power control. Any backhaul or network interconnection, such as the X2 interface, may be used for signal forwarding or information exchange between BS₁ and BS₂.

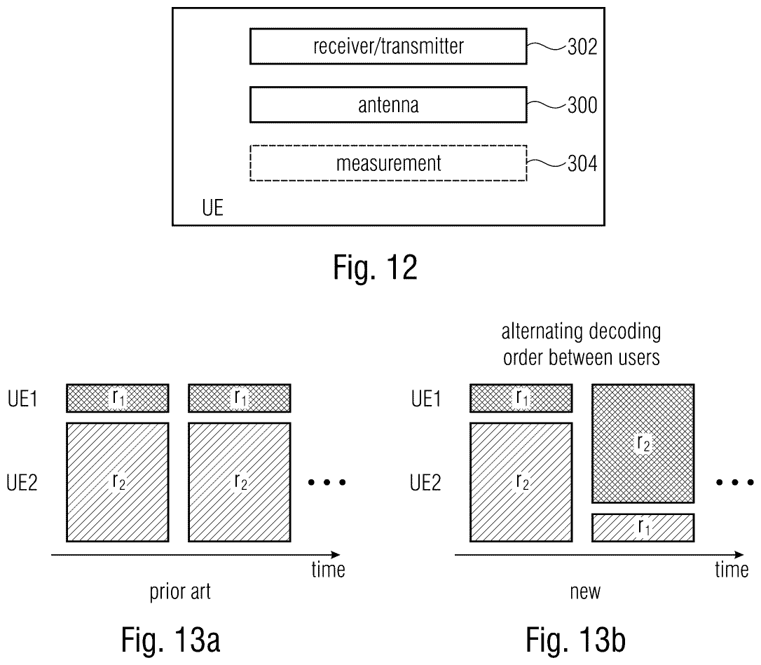

FIG. 12 is a schematic block diagram of a user in accordance with embodiments of the present invention. The UE depicted in FIG. 12 may be a user in the wireless communication network as described above with reference to FIG. 1 to FIG. 3, which includes a plurality of base stations, each of which serves one or more users in the wireless communication network. The UE depicted in FIG. 12 may be served by a plurality of base stations to receive, via the antenna 300 and the receiver/transmitter circuit 302, a first data signal from a first base station and a second data signal from a second base station using multi-user superposition transmission. Further, the UE receives, via the antenna 300 and the receiver/transmitter circuit 302, the above mentioned MUST settings for performing the mapping on a superposition of the first and second data signals to obtain information data per data signal.

In accordance with further embodiments, the user equipment may optionally include a measurement circuitry 304 to measure one or more of (i) a phase offset between channels via which the user equipment receives the first and second data signals, (ii) an attenuation on the channels, and (iii) an interference on the channels. The measurement circuitry 304 may include, for example, the phase-shift estimator and the power ratio estimator described above with reference to FIG. 9. Using the receiver/transmitter circuit 302 and the antenna 300 the UE may signal the measurement results to the one or more base stations serving the UE. In accordance with embodiments, the phase-shift compensation signal sender, the power ration compensation sender and the demapper may be part of the receiver/transmitter circuit 302.

Information needed at the user(s), like MUST layer assignment or a swapping pattern (see below) may be signaled to the user(s), for example for a TTI, in a static way using RRC, in a dynamic way using DCI messages in the PDCCH, or by semi-persistent scheduling (SPS).

In the embodiments described above with reference to FIG. 7 to FIG. 11, especially in the examples explained with reference to FIG. 10 and FIG. 11, the distance between the respective UEs from the base stations BS₁, BS₂ has been shown to be the same. However, in accordance with other embodiments the UE of FIG. 10 may be located closer to BS₁ or closer to BS₂. In a similar way, in FIG. 11(a), UE₁ may be closer to BS₁ or closer to BS₂ and, likewise UE₂ may be closer to BS₁ or closer to BS₂. In either case, when implementing a data transmission using MUST, the achievable data rates on the links between the base stations and the UE may deteriorate, e.g., when a distances of an UE to the respective base stations is the same leading to equal or substantially equal SNRs for a received. This may occur for a transmission from the base station BS₁ to UE and for a transmission from the base station BS₂ to the UE in the embodiment of FIG. 10 or for transmitting data from BS₁ to UE₁ and from BS₂ to UE₂ in the embodiment of FIG. 11.

To address this problem and to avoid a reduction in the rate of data transmitted over the respective links the layer mapping between two MUST users is alternated, as is illustrated in FIG. 13 illustrating the data rate over time using MUST for users having equal or substantially equal SNR. In FIG. 13(a) the data rate as achievable over time, like over several TTIs or slots, by known approaches are indicated, and it can be seen that the data rates remain low for UE₁ while they remain high for UE₂. To address this drawback, in accordance with the inventive approach, as depicted in FIG. 13(b), during a first transmission period, the data of a first data signal is mapped by the base station using a first MUST layer having a first transmit constellation and/or a first power allocation, and data of the second data signal is mapped by the further base station using a second MUST layer having a second transmit constellation and/or a second power allocation. This yields the initial rates r₁ and r₂ that correspond to those achieved in known technology. However, other than in the known technology, in the next transmission period, the second transmission period, the MUST pattern alternates in that now data for the first data signal is mapped by the base station using the second MUST layer, and data of the second data signal is mapped by the other base station using the first MUST layer so that the higher rate r₂ is associated with UE₁ and the lower rate r₁ is associated with UE₂.

In other words, as depicted in FIG. 13(b), the data mapping between the two MUST users UE₁ and UE₂ alternates which provides for a substantially constant sum-rate over time. For example, of the base stations using alternating transmission patterns, one base station modulates the subset of resources, like REs of an RB, in a MUST-near manner, and the complement of the resources are modulated in a MUST-far manner. The other base station uses the complementary modulation pattern. In accordance with embodiments the interleaver at the base stations is designed using this pattern. In accordance with embodiments, the decoding pattern during a MUST transition is indicated to the respective users, for example by signaling a MUST-near-far swapping pattern which indicates the decoding order for each user. For example, this may be received at the UE of FIG. 12 via the antenna and the receiver/transmitter circuit.

The above embodiments have been described in the context of base stations and users as they are found in wireless communication networks as depicted in FIG. 1, however, the inventive approach is equally applicable to heterogeneous networks including macrocells and small cells. For example, the approach as described above with reference to FIG. 7 to FIG. 13 may be applied for serving one or more UEs by a macrocell base station and by one or more small cell base stations, like femtocell base stations or pico cell base stations. In such scenarios, in accordance with embodiments, the macrocell base station may have the above mentioned fixed phase for its constellation map and only the small cell base stations adapt their constellation by pre-rotation on the basis of the phase offset information for the phase offset compensation as described above. The macrocell base station may inform the small cell base stations, via the backhaul links, about the MUST setting for one or more users commonly using MUST. In accordance with yet a further embodiment, one or more UEs may be served by one or more macrocell base stations and by one or more small cell base stations.

In the embodiments described above, it has been assumed that the multiple base stations perform a joint MUST encoding, and that the encoding is performed at each of the base stations involved. However, the present invention is not limited to such an approach, rather the joint MUST encoding may also be done in a distributed way. For example, one base station may perform the MUST encoding step and transmit the MUST layer to the one or more base stations involved in the data transmission using MUST via the backhaul connection or a fast interconnect among the base stations. Thus, in accordance with such embodiments the base station may map the second data signal to be provided to the UE using a second transmit constellation which is set in accordance with a negotiated MUST setting. Via the backhaul interface, the mapped data of the second data signal is transmitted to the second base station serving the UE for a wireless transmission of the second data signal using the second transmit constellation to the one or more users which are served by the second base station.

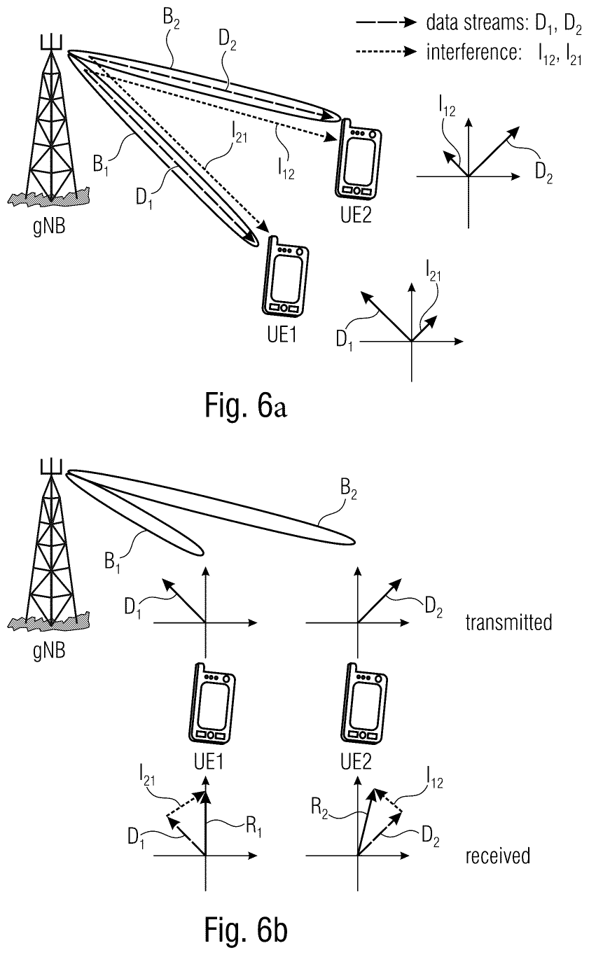

In the following, a further embodiment of the inventive approach addressing the problem of cross-layer interference between MIMO layers will be addressed. As has been described above with reference to FIG. 6, when serving a plurality of users by a single base station via a plurality of beams, the receive signal at the respective users also includes interference components which may result in an overall signal received at the UE that may not be decodable. Such situations may occur due to cross-layer interference or cross-talk between the respective transmit beams formed and transmitted by the base station towards the respective UEs. This may apply in situations, in which the beams are directed towards a position where the UE is assumed to be located, however, in practice, the respective UE is not at the exact position, but may be at a position offset which may increase the problem of cross-talk and the associated performance degradation.

In accordance with embodiments of the present invention, this problem is addressed by exploiting the knowledge of the cross-talk between the MIMO layers, in a similar way as it is done in accordance with vectoring processes. The base station may estimate the cross-talk between the MIMO layers, and since it also knows both transmissions to the users it may estimate the cross-talk impact on the transmission to the others so that the base station may precode the MIMO layers such that the cross-talk is compensated.

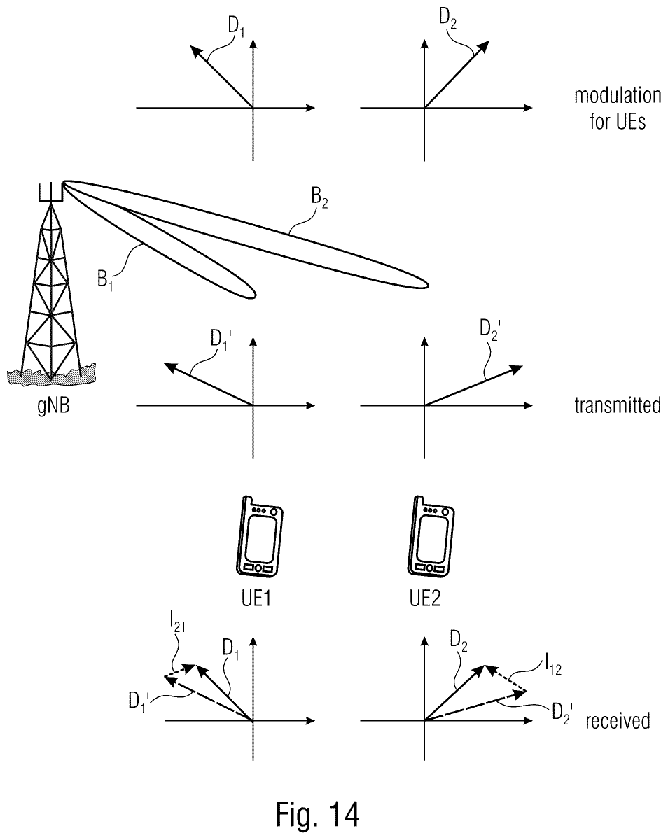

FIG. 14 illustrates the compensation of cross-talk in accordance with an embodiment of an inventive approach. FIG. 14 shows, like FIG. 6, the base station gNB emitting the beams B₁ and B₂ for transmitting the first and second data signals D₁ and D₂. The data signal D₁, D₂ for the users UE₁ and UE₂ is mapped, initially, to the desired constellation point which, for UE₁ is in the upper left quadrant, and for UE₂ is in the upper right quadrant, as shown in the uppermost constellation diagram in FIG. 14. In accordance with the inventive approach, on the basis of the knowledge of the cross-talk or occurring interferences between the beams B₁ and B₂, the base station gNB performs a predistortion of the signals to be transmitted to the UEs. The signals, which are actual transmitted via the beams B₁ to B₂, take into consideration the cross-talk or interferences I₁₂, I₂₁ so that the actually transmitted signals D₁′ and D₂′ point to different constellation points, as is depicted in the center constellation diagram in FIG. 14. At UE₁ and UE₂, as is depicted in the lowermost receive constellation diagram in FIG. 14, the predistorted data signal D₁′ and D₂′ is adjusted back to the desired constellation point due to the interference I₂₁ experienced at UE₁ and due to the interference I₁₂ experienced at UE₂, respectively.

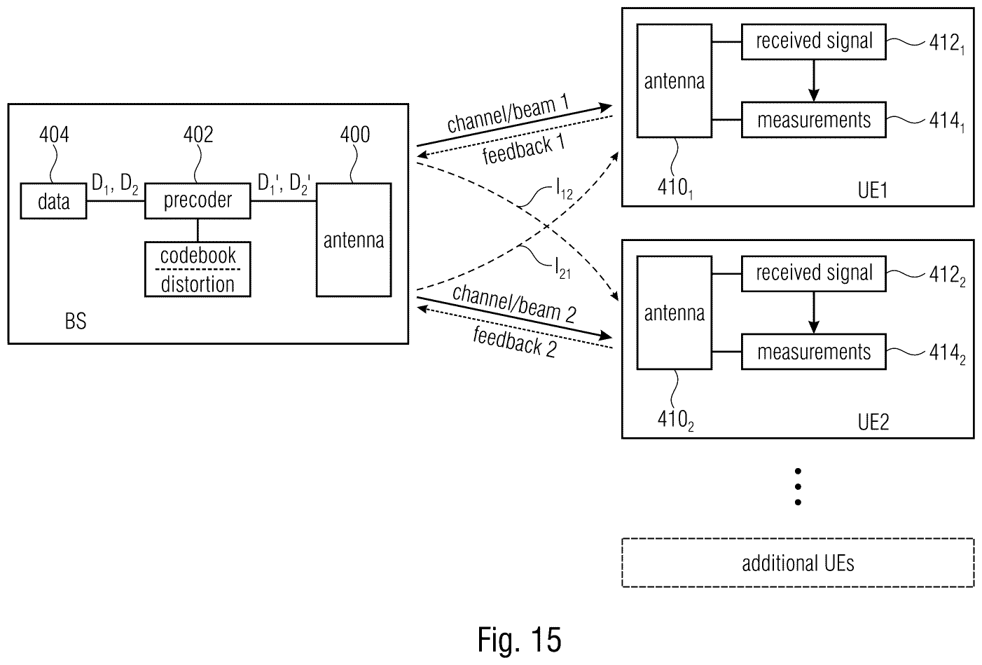

FIG. 15 illustrates a block diagram of a network for implementing the approach described with reference to FIG. 14. FIG. 15 shows a base station BS that may be used in a wireless communication network as described above with reference to FIG. 1 to FIG. 3. The base station BS is to serve the two users UE₁ and UE₂. In accordance with other embodiments, more than two users may be served, as is indicated in FIG. 15 by the dashed box labeled “additional UEs”. A first user UE₁ is served by the base station BS to receive the first data signal D₁, and the second user UE₂ is served by the base station BS to receive the second data signal D₂. The base station BS includes an antenna 400, which may include a plurality of antenna elements or an antenna array including plural antenna elements for forming multiple beams B₁, B₂ for simultaneously transmitting the data D₁, D₂ to the respective users UE₁ and UE₂. The antenna 400 allows for a wireless communication to UE₁ and to UE₂ served by the base station BS. The base station further includes a precoder 402 that is connected to the antenna 400 to cause the antenna 400 to form the first transmit beam B₁ to transmit the first data signal D₁ to the first user UE, and to form the second transmit beam B₂ to transmit the second data signal D₂ to the second user. For transmitting the first data signal to the first user, the base station maps the data of the first data signal using a first transmit constellation, and for transmitting the second data signal for the second user, the base station maps the data of the second data signal using a second transmit constellation. The precoder 402, responsive to an estimated cross-talk between the first and second transmit beams B₁ and B₂, applies a predistortion so that the signals actually transmitted are not the data signals D₁, D₂ but the predistorted data signals D₁′ and D₂′ as has been explained above with reference to FIG. 14.

In accordance with embodiments, the base station BS receives data to be transmitted to UE₁ and UE₂, as is indicated at 404. The data D₁, D₂ is applied to the precoder 402 which receives from the codebook respective weights for forming the respective beams by the antenna 400 and additional predistortion coefficients for generating the predistorted transmit data signals D₁′ and D₂′. In accordance with embodiments, the base station receives feedback information via one or more feedback channels from UE₁ and from UE₂ obtained at the respective users by measurements of the channel, on the basis of which the base station may estimate the cross-talk. In accordance with embodiments, the base station may estimate the cross-talk using measurements received from one or more of the users. The base station may receive information from the users about an attenuation and a phase shift on the channels between the base station and the users. Appropriate distortion coefficient(s) may be selected using the feedback and may be applied together with the codebook coefficient to the precoder for achieving the predistorted signals D₁′ and D₂′. In accordance with other embodiments, the cross-talk is estimated at the one or more of the users, and the base station may receive the estimate of the cross-talk from one or more of the users.

FIG. 15 also shows how a UE may be implemented for operating in accordance with the embodiment described with reference to FIG. 14 and FIG. 15. Only UE₁ will be described in detail, however, the other UEs may have a similar structure. UE₁includes an antenna 410₁, via which a signal on the respective channel connected to the base station is received, as is indicated at 412₁. The received signal 412₁ includes signal components stemming from the signal transmitted via beam B₁, as well as signal components stemming from the signal transmitted by beam B₂, namely the interference components I₂₁. UE₁ further includes a measurement circuitry 440₁ for performing channel estimation, for example on the basis of reference signals sent by the base station on the two channels initially or at specific times during the transmission so as to allow for an estimation of the channel. The reference signals may include the phase estimate reference signals described above with reference to FIG. 9 and the measurement circuitry 414₁ may have a structure as described above with reference to FIG. 9. On the basis of the signals received from the base station, namely the reference signals, an attenuation of the channels, a channel quality, a phase offset between the channels and an interference among the channels, namely cross-talk, may be determined. The feedback information may be sent to the base station via the antenna 410₁ so as to allow for the above described predistortion of the data signal. In other words, in accordance with embodiments the UE, by means of the measurement circuitry 414₁, is in the position to provide vectoring parameters for the first and second transmit beams, on the basis of which the predistortion is performed at the base station for compensating the cross-talk I₁₂, I₂₁ at the users UE₁ and UE₂. In accordance with other embodiments, the measurement circuitry 414₁ may use a measurement and estimation of a phase shift and an attenuation at the UE to estimate the cross-talk, and the UE transmits the estimate of the cross-talk to the base station, rather than transmitting the complete measurement.

The transmission of the reference signal for estimating the cross-talk on the basis of measurements performed by the UEs which are fed back to the base station may occur prior to starting a transmission of data to the two users and/or may occur periodically during a time period during which data is sent to the UEs.

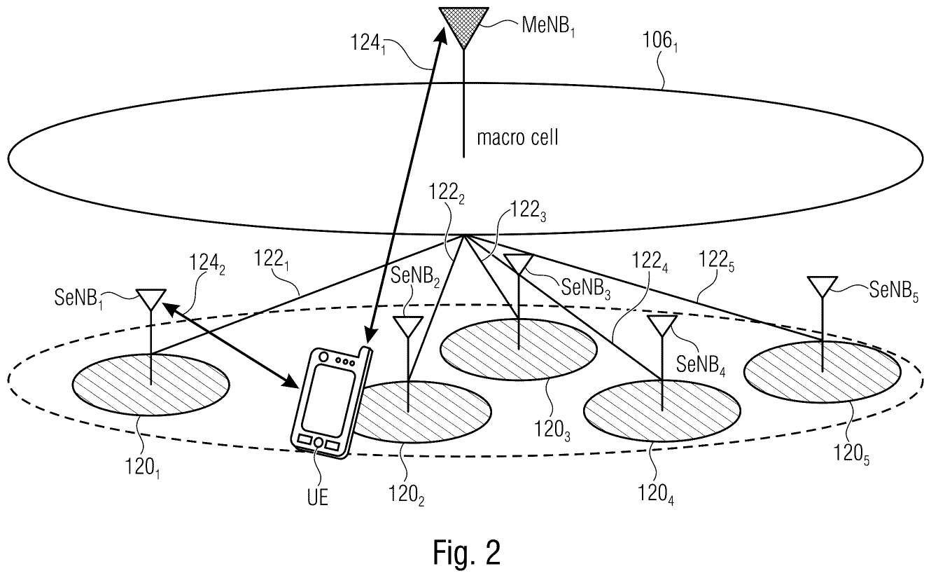

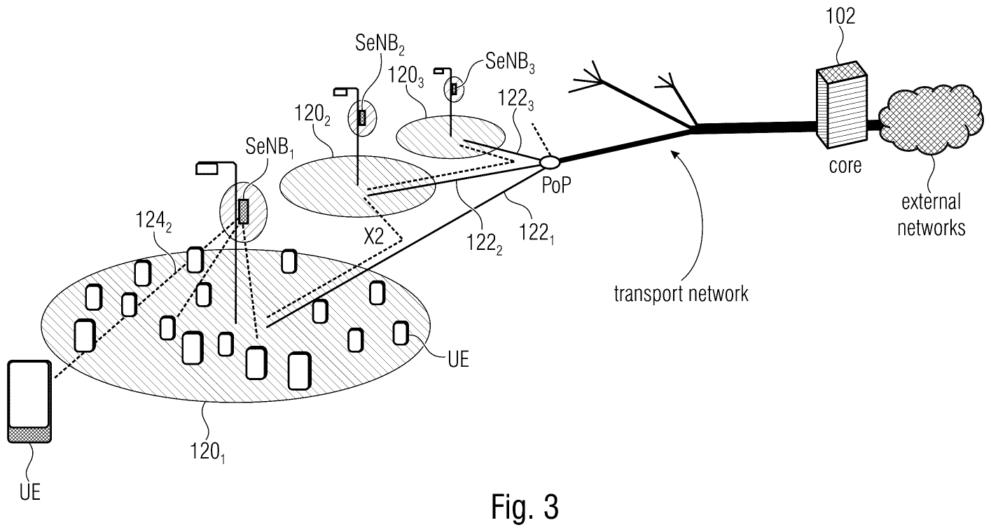

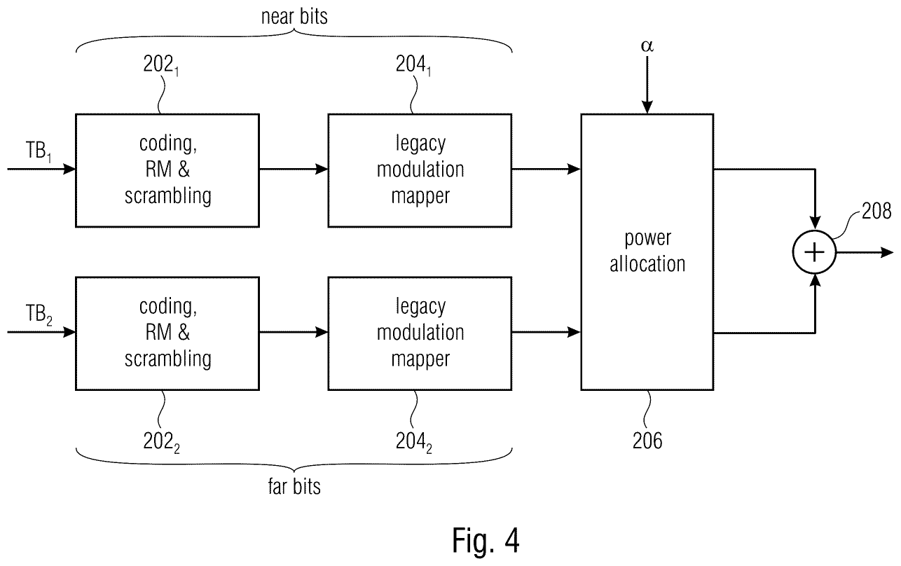

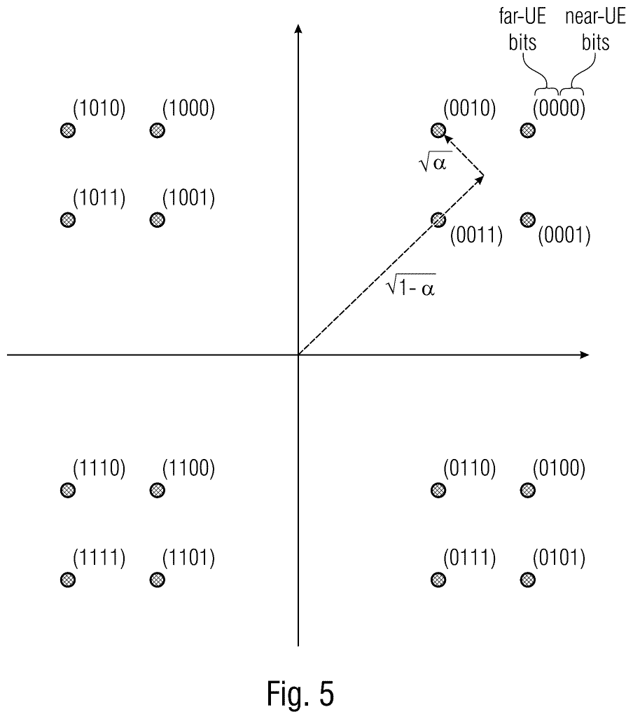

In the embodiments described above with reference to FIG. 14 and FIG. 15, reference is made to a base station, like a base station in the wireless communication network of FIG. 1, however, the base station may also be a macro base station as used in the heterogeneous networks of FIG. 2 and FIG. 3 or it may be a small cell base station in such a network. In accordance with the other embodiments, the base station may also be implemented by a user equipment having MIMO capabilities and being served by a macrocell base station or a small base station or both, for example in accordance with the teachings described with reference to FIG. 7 to FIG. 13 of the present application. Such a UE may be used, for example as a relay, for further transmitting data using the two beams simultaneously to further UEs connected to the relay UE via a side link connection. The relay UE may be a mobile phone while the connected UEs may be variable IoT devices, like smartwatches.

Although some aspects of the described concept have been described in the context of an apparatus, it is clear that these aspects also represent a description of the corresponding method, where a block or a device corresponds to a method step or a feature of a method step. Analogously, aspects described in the context of a method step also represent a description of a corresponding block or item or feature of a corresponding apparatus.

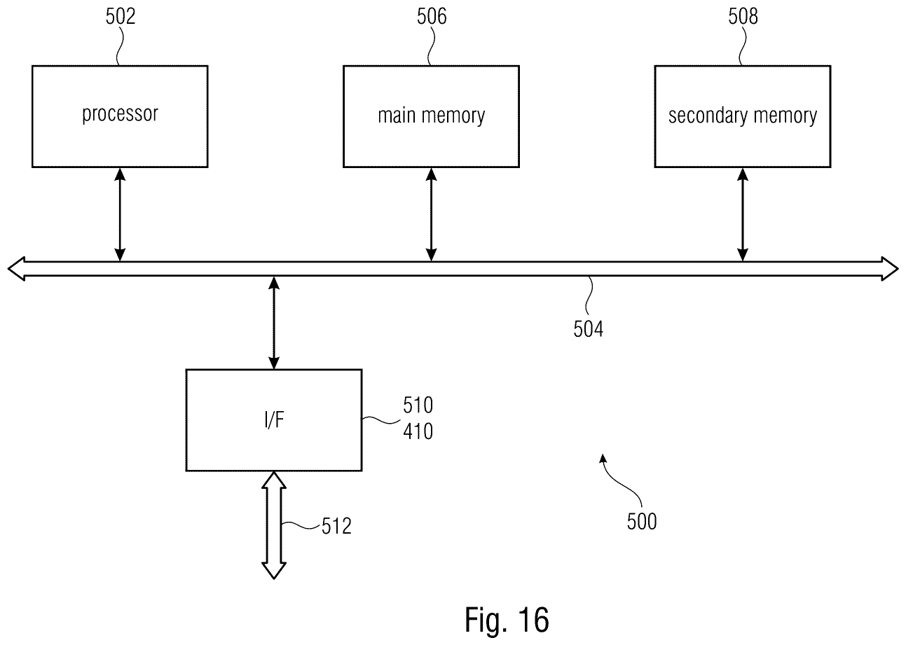

Various elements and features of the present invention may be implemented in hardware using analog and/or digital circuits, in software, through the execution of instructions by one or more general purpose or special-purpose processors, or as a combination of hardware and software. For example, embodiments of the present invention may be implemented in the environment of a computer system or another processing system. FIG. 16 illustrates an example of a computer system 500. The units or modules as well as the steps of the methods performed by these units may execute on one or more computer systems 500. The computer system 500 includes one or more processors 502, like a special purpose or a general purpose digital signal processor. The processor 502 is connected to a communication infrastructure 504, like a bus or a network. The computer system 500 includes a main memory 506, e.g., a random access memory (RAM), and a secondary memory 508, e.g., a hard disk drive and/or a removable storage drive. The secondary memory 508 may allow computer programs or other instructions to be loaded into the computer system 500. The computer system 500 may further include a communications interface 510 to allow software and data to be transferred between computer system 500 and external devices. The communication may be in the form electronic, electromagnetic, optical, or other signals capable of being handled by a communications interface. The communication may use a wire or a cable, fiber optics, a phone line, a cellular phone link, an RF link and other communications channels 512.

The terms “computer program medium” and “computer readable medium” are used to generally refer to tangible storage media such as removable storage units or a hard disk installed in a hard disk drive. These computer program products are means for providing software to the computer system 500. The computer programs, also referred to as computer control logic, are stored in main memory 506 and/or secondary memory 508. Computer programs may also be received via the communications interface 510. The computer program, when executed, enable the computer system 500 to implement the present invention. In particular, the computer program, when executed, enable processor 502 to implement the processes of the present invention, such as any of the methods described herein. Accordingly, such a computer program may represent a controller of the computer system 500. Where the disclosure is implemented using software, the software may be stored in a computer program product and loaded into computer system 500 using a removable storage drive, an interface, like communications interface 510.

The implementation in hardware or in software may be performed using a digital storage medium, for example cloud storage, a floppy disk, a DVD, a Blue-Ray, a CD, a ROM, a PROM, an EPROM, an EEPROM or a FLASH memory, having electronically readable control signals stored thereon, which cooperate (or are capable of cooperating) with a programmable computer system such that the respective method is performed. Therefore, the digital storage medium may be computer readable.

Some embodiments according to the invention comprise a data carrier having electronically readable control signals, which are capable of cooperating with a programmable computer system, such that one of the methods described herein is performed.

Generally, embodiments of the present invention may be implemented as a computer program product with a program code, the program code being operative for performing one of the methods when the computer program product runs on a computer. The program code may for example be stored on a machine readable carrier.

Other embodiments comprise the computer program for performing one of the methods described herein, stored on a machine readable carrier. In other words, an embodiment of the inventive method is, therefore, a computer program having a program code for performing one of the methods described herein, when the computer program runs on a computer.

A further embodiment of the inventive methods is, therefore, a data carrier (or a digital storage medium, or a computer-readable medium) comprising, recorded thereon, the computer program for performing one of the methods described herein. A further embodiment of the inventive method is, therefore, a data stream or a sequence of signals representing the computer program for performing one of the methods described herein. The data stream or the sequence of signals may for example be configured to be transferred via a data communication connection, for example via the Internet. A further embodiment comprises a processing means, for example a computer, or a programmable logic device, configured to or adapted to perform one of the methods described herein. A further embodiment comprises a computer having installed thereon the computer program for performing one of the methods described herein.

In some embodiments, a programmable logic device (for example a field programmable gate array) may be used to perform some or all of the functionalities of the methods described herein. In some embodiments, a field programmable gate array may cooperate with a microprocessor in order to perform one of the methods described herein. Generally, the methods may be performed by any hardware apparatus.

While this invention has been described in terms of several embodiments, there are alterations, permutations, and equivalents which will be apparent to others skilled in the art and which fall within the scope of this invention. It should also be noted that there are many alternative ways of implementing the methods and compositions of the present invention. It is therefore intended that the following appended claims be interpreted as including all such alterations, permutations, and equivalents as fall within the true spirit and scope of the present invention.

### REFERENCES

[1] NGMN Alliance A White Paper “Small Cell Backhaul Requirements”, Version 1.0, Jun. 4, 2012
[2] 3GPP TR 36.859 v13.0.0 (2015-12)

Abbreviations

| | |
|---|---|
| eNB | Evolved Node B |
| LTE | Long-Term Evolution |
| IRC | Interference Rejection Combining |
| SIC | Successive Interference Cancellation |
| UE | User Equipment (User Terminal) |
| RRM | Radio Resource Management |
| TDD | Time Division Duplex |
| FDD | Frequency Division Duplex |
| MIMO | Multiple Input Multiple Output |
| OFDM | Orthogonal Frequency Division Duplexing |
| OFDMA | Orthogonal Frequency-Division Multiple Access |
| CQI | Channel Quality Information |
| CRC | Cyclic Redundancy Check |
| DMRS | Demodulation Reference Signal |
| SPS | Semi-persistent Scheduling |
| DCI | Downlink Control Information |
| UL | Uplink |
| DL | Downlink |
| (s)TTI | (short) Transmission Time Interval |
| PUSCH | Physical Uplink Shared Channel |
| PUCCH | Physical Uplink Control Channel |
| PDSCH | Physical Downlink Shared Channel |
| PDCCH | Physical Downlink Control Channel |
| SIC | Successive Interference Cancellation |
| URLLC | Ultra-reliable Low-latency Communications |
| MBSFN | Multimedia Broadcast Single Frequency Network |
| C-RNTI | Cell Radio Network Temporary Identity |

1. (canceled)

2. (cancelled)

3. (canceled)

4. (cancelled)

5. (canceled)

6. (cancelled)

7. (canceled)

8. (cancelled)

9. (canceled)

10. (cancelled)

11. (canceled)

12. (cancelled)

13. (canceled)

14. (cancelled)

15. (canceled)

16. (cancelled)

17. (canceled)

18. (canceled)

19. (canceled)

20. (canceled)

21. (canceled)

22. (canceled)

23. (canceled)

24. (canceled)

25. A user equipment for a wireless communication network, the wireless communication network comprising one or more base stations, one base station serving two or more user equipments using respective spatially precoded or beamformed transmit resources
wherein the user equipment receives from the base station using spatially precoded or beamformed first and second transmit resources and measures one or more of a phase offset between the first and second transmit resources and an attenuation or power level on the first and second transmit resources and
wherein the user equipment receives, on the first and second transmit resources, predefined reference signals for measuring the phase offset and/or the attenuation or power level.

26. The user equipment of claim 25, wherein the user equipment signals to a network entity of the wireless communication network one or more of the following: the phase offset between the first and second transmit resources, the attenuation or power level on the first and second transmit resources.

27. The user equipment of claim 25, wherein the user equipment receives from a network entity of the wireless communication network a configuration of the predefined reference signals for measuring the phase offset and/or the attenuation or power level.

28. The user equipment of claim 26, wherein the user equipment signals the phase offset and/or the attenuation or power level to the network entity using Uplink Control Information (UCI) or Radio Resource Control (RRC) signaling.

29. A wireless communication network, comprising:
at least one base station and one or more user equipments wherein
the user equipment receives from the base station using spatially precoded or beamformed first and second transmit resources, and measures a phase offset between the first and second transmit resources and an attenuation or power level on the first and second transmit resources, and
the user equipment receives, on the first and second transmit resources, predefined reference signals for measuring the phase offset and the attenuation or power level.

30. The wireless communication network of claim 29, wherein
the at least one base station comprises one or more of a macro cell base station and a small cell base station; and
the user equipments comprise one or more of mobile terminals, IoT devices, physical devices, ground based vehicles, aerial vehicles, drones, buildings and other items provided with network connectivity.

31. The communication network of claim 29, using an Inverse Fast Fourier Transform, IFFT, based signal, wherein the IFFT based signal comprises Orthogonal Frequency-Division Multiplexing, OFDM, with cyclic prefix, CP, Discrete Fourier Transform-Spread-Orthogonal Frequency Division Multiplexing, DFT-s-OFDM, with CP, IFFT-based waveforms without CP, filtered OFDM, f-OFDM, filter-bank based multi-carrier, FBMC, Generalized Frequency Division Multiplexing, GFDM, or Universal Filter Multi Carrier, UFMC.

32. (canceled)

33. A method for operating a user equipment for a wireless communication network, the wireless communication network comprising one or more base stations, the method comprising:
serving, by a base station, the user equipment using spatially precoded or beamformed transmit resources,
receiving, by the user equipment, from the base station using spatially precoded or beamformed first and second transmit resources and measuring a phase offset between the first and second transmit resources and an attenuation or power level on the first and second transmit resources, and
wherein the user equipment receives, on the first and second transmit resources, predefined reference signals for measuring the phase offset and the attenuation or power level.

34. (canceled)

35. A non-transitory digital storage medium having stored thereon a computer program for performing, when said computer program is run by a computer, a method for operating a user equipment for a wireless communication network, the wireless communication network comprising one or more base stations, the method comprising:
serving, by a base station, the user equipment using spatially precoded or beamformed transmit resources,
receiving, by the user equipment, from the base station using spatially precoded or beamformed first and second transmit resources and measuring a phase offset between the first and second transmit resources and an attenuation or power level on the first and second transmit resources, and
wherein the user equipment receives, on the first and second transmit resources, predefined reference signals for measuring the phase offset and the attenuation or power level.
